(19) United States
(12) Patent Application Publication
(10) Pub. No.: US 2011/0245088 A1
(43) Pub. Date: Oct. 6, 2011

(54) AMIDE-BASED SOLUTION-PHASE DERIVED LIBRARY AND METHOD FOR SCREENING THEREOF

(75) Inventors: Chung-Shan Yu, Hsinchu (TW); Li-Wu Chiang, Hsinchu (TW); Shao-Wei Chen, Hsinchu (TW); Chia-Wen Huang, Hsinchu (TW); Ho-Lien Huang, Hsinchu (TW); Kai Pei, Hsinchu (TW)

(73) Assignee: NATIONAL TSING HUA UNIVERSITY, Hsinchu (TW)

(21) Appl. No.: 12/754,151

(22) Filed: Apr. 5, 2010

(51) Int. Cl. C40B 30/00; C40B 40/04

(52) U.S. Cl. 506/7; 506/15

(57) ABSTRACT

An amide-based library is disclosed in the invention which is prepared via amide bond formation coupling an amine with a carboxylic acid. Also, a method using said library for screening a drug candidate is provided in the present invention. Compounds in the present invention having cytotoxicities are useful for a variety of therapeutic applications.

### FIELD OF THE INVENTION

The present invention is related to an amide-based solution phase derived library and a method using said library for screening a drug candidate.

### BACKGROUND OF THE INVENTION

There has been growing interest in a method combining a solution-phase derived library with an in-situ bioassay on microtiter plate. (Brik A., Wu C.-Y., Wong C.-H., Org. Biomol. Chem., 4, 1446-1457, 2006). Construction of the library is initiated through a core compound, either as a lead of natural product or a transition-state analog from mechanistic considerations, followed by coupling with various carboxylic acids as building blocks. The libraries were constructed on a microtiter plate or a set of centrifuge tubes. In each well or tube, the products obtained were screened for their binding affinity for the enzyme of interest. The bioactivity derived from the mixture, in general, is consistent with that of the purified product. Indeed, a number of potential substrates for numerous enzymes including: sulfotransferase, fucosidase, fucosyltransferase, protease, and protease dimerization, have been discovered by this approach. (Best M., Brik A., Chapman E., Lee L., Cheng W.-C., Wong C.-H., ChemBioChem, 5, 811-819, (2004); Wu C.-Y., Chang, C.-F., Chen J. S. Y., Lee, S.-T., Wong C.-H., Lin, C.-H., Angew. Chem.-Int. Edit., 42, 4661-4664, (2003); Lee L. V., Mitchell M. L., Huang S. J., Fokin V. V., Sharpless K. B., Wong C. H., J. Am. Chem. Soc., 125, 9588-9589, (2003); Brik A., Lin Y.-C., Elder J. Wong C.-H., Chem. Biol., 9, 891-896, (2002); Lee S. G., Chmielewski J., Chem. Biol., 13, 421-426, (2006)). Since this method is mainly focused on enzymatic assays, a further application in cellular assays may be of importance. Accordingly, there is a need for coupling the amide-based libraries with a cell-line based assay, to realize the full mechanisms related to bioactivity of potential amides.

### SUMMARY OF THE INVENTION

In accordance with this invention, an amide-based library is provided, in which the library is performed in a solution phase comprising a plurality of amides prepared by coupling an amine with a carboxylic acid, wherein pKa value of said amine is greater than pKa value of said amide.

This invention is also related to a method for screening a drug candidate comprising:

providing an amide-based library as described above;

diluting said amide-based library in a water-phase;

incubating each amide in the library with a cell line; and

treating the amide of the library and the cell line with a bioassay reagent and recording the absorbance.

Thus, the invention provides a new approach to explore candidate drugs.

### BRIEF DESCRIPTION OF THE DRAWINGS

FIG. 1: Libraries constructed through a coupling of three core amines with carboxylic acids. In this figure, “1” represents the core amine of 5′-amino-5′-deoxy uridine; “2” represents the core amine of 5′-amino-2′,5′-di-deoxy arabinosyl uridine; “3” represents the core amine of butan-1-amine; “U1-U30” represents the coupling product of 5′-amino-5′-deoxy uridine and D1-D30 of carboxylic acid carboxylic acids; “A1-A30” represents the coupling product of 5′-amino-2′,5′-di-deoxy arabinosyl uridine and D1-D30 of carboxylic acid; “C1-C28” represents the coupling product of butan-1-amine and D1-D28 of carboxylic acid carboxylic acids.

FIG. 2(a)-(c): Carboxylic acids as building blocks for amide bond formation, wherein D1-D30 respectively represents the carboxylic acid as follows: D1: benzoic acid; D2:4-vinylbenzoic acid; D3: 4-butylbenzoic acid; D4: 2-methoxybenzoic acid; D5: 3,4,5-trimethoxybenzoic acid; D6: 2-hydroxy-4-methylbenzoic acid; D7: 4-(methylamino)benzoic acid; D8: 6-methylnicotinic acid; D9: 5-oxopyrrolidine-2-carboxylic acid; D10: 2-hydroxy-2-phenylacetic acid; D11: 2-(4-isobutylphenyl)propanoic acid; D12: 5-(2,5-dimethylphenoxy)-2,2-dimethylpentanoic acid; D13: (E)-3-(4-hydroxy-3-methoxyphenyl)acrylic acid; D14: (E)-4-phenylbut-3-enoic acid; D15: 2-(2,3-dichloro-4-(2-methylenebutanoyl)phenoxy)acetic acid; D16:3-(4-fluorobenzoyl)benzoic acid; D17:3′,4′-difluoro-4-hydroxy-[1,1′-biphenyl]-3-carboxylic acid; D18: 4-([1,1′-biphenyl]-4-yl)-4-oxobutanoic acid; D19: 3-(1H-indol-3-yl)propanoic acid; D20: 8-ethyl-5-oxo-2-(piperazin-1-yl)-5,8-dihydropyrido[2,3-d]pyrimidine-6 carboxylic acid, D21: (2S,4S,5R,6R)-5-acetamido-2,4-dihydroxy-6-((1R,2R)-1,2,3-trihydroxypropyl)tetrahydro-2H-pyran-2-carboxylic acid; D22: 2,2-dibromoacetic acid; D23: 2-phosphonoacetic acid; D24: (E)-4-(ethylamino)-4-oxobut-2-enoic acid, D25: 2-(dimethylamino)acetic acid, D26: 2-hydroxy-3-methylbutanoic acid, D27: dodecanoic acid; D28: heptadecanoic acid; D29: 2-bromohexadecanoic acid, and D30: 2-(bis(phosphonomethyl)amino)acetic acid.

FIG. 3: Flowchart of the dilution process.

FIG. 4: (a) Assay of cytotoxicity against A549 cell line by the libraries prepared from uridine analogue 1 and arabinosyl uridine analogue 2, (b) assay of cytotoxicity against MCF-7 cell line by the libraries prepared from uridine analogue 1 and arabinosyl uridine analogue 2 and (c) assay of cytotoxicity against MCF-7 cell lines by the libraries prepared from n-butanamine. In this figure, “P” represents Cisplatin.

FIG. 5: Lipid-containing compounds used in the bioassay.

FIG. 6: (a) Docking of SPh-1 to the active site defined by the ligand of ceramide, (b) schematic representation of the electronic clouds of amino acid residues participating in the binding to Sph-1, (c) amino acid residues participating in the binding to Sph-2 and (d) amino acid residues participating in the binding to U27.

FIG. 7: (a) The amino acid residues of 1 CQE participating in direct binding to flurbiprofen, (b) the amino acid residues of 1 CQE participating in direct binding to butyl fenbufen and (c) the amino acid residues of 1 CQE participating in direct binding to fenbufen.

FIG. 8: (a) Residues of active site of Bcl-x responsible for the binding to butylfenbufen and (b) binding of 4-FC and TN1 to 1YSG (Bcl-x) biphenyl ring extending into the active site.

FIG. 9: (a) 2gss docking with ethacrynic acid and (b) 2gss docking with butyl ethacrynic amide C15.

### DETAILED DESCRIPTION OF THE INVENTION

### Definitions

In describing and claiming the invention, the following terminology will be used in accordance with the definitions set forth below.

As used herein, the term “pKa value” is related to the Ka value in a logic way. The Ka value, also called the dissociation constant, the ionisation constant, and the acid constant, is used to describe the tendency of compounds or ions to dissociate. The pKa value is defined from Ka, and can be calculated from the Ka value from the equation pKa=−Log 10(Ka). In the invention, the pKa value can be found in Bruice Organic Chemistry.

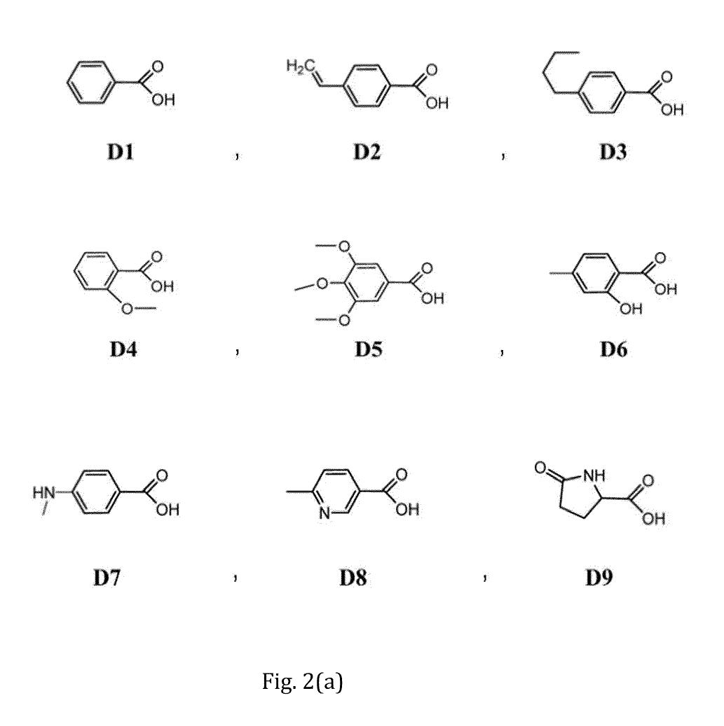

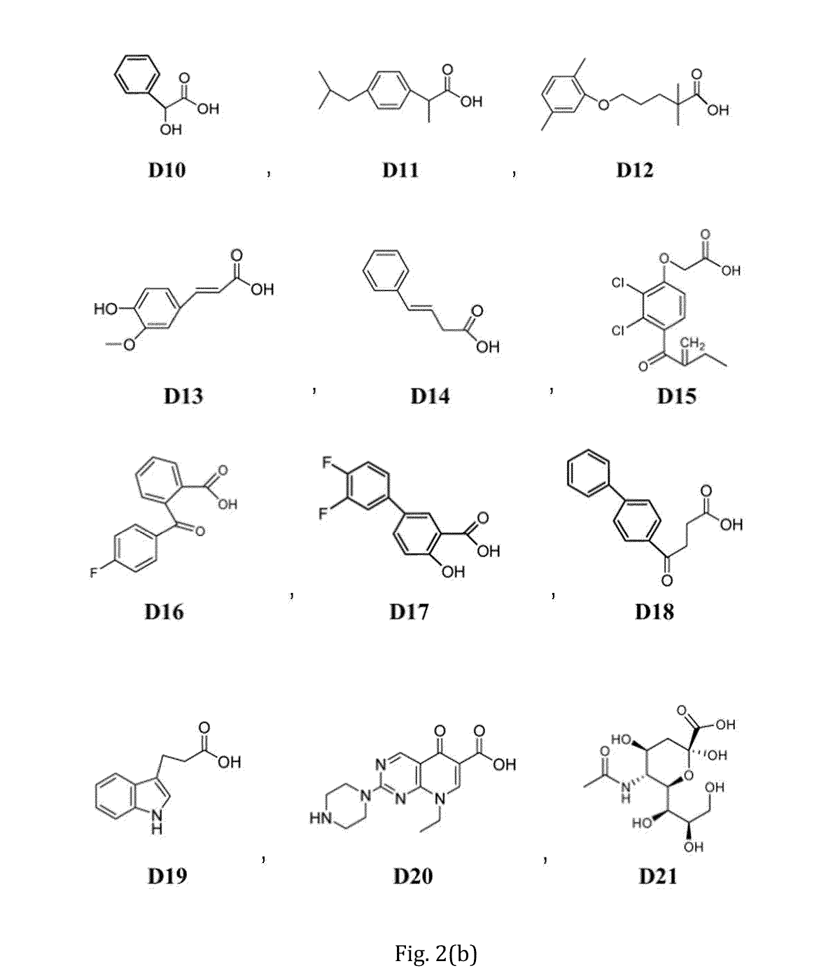

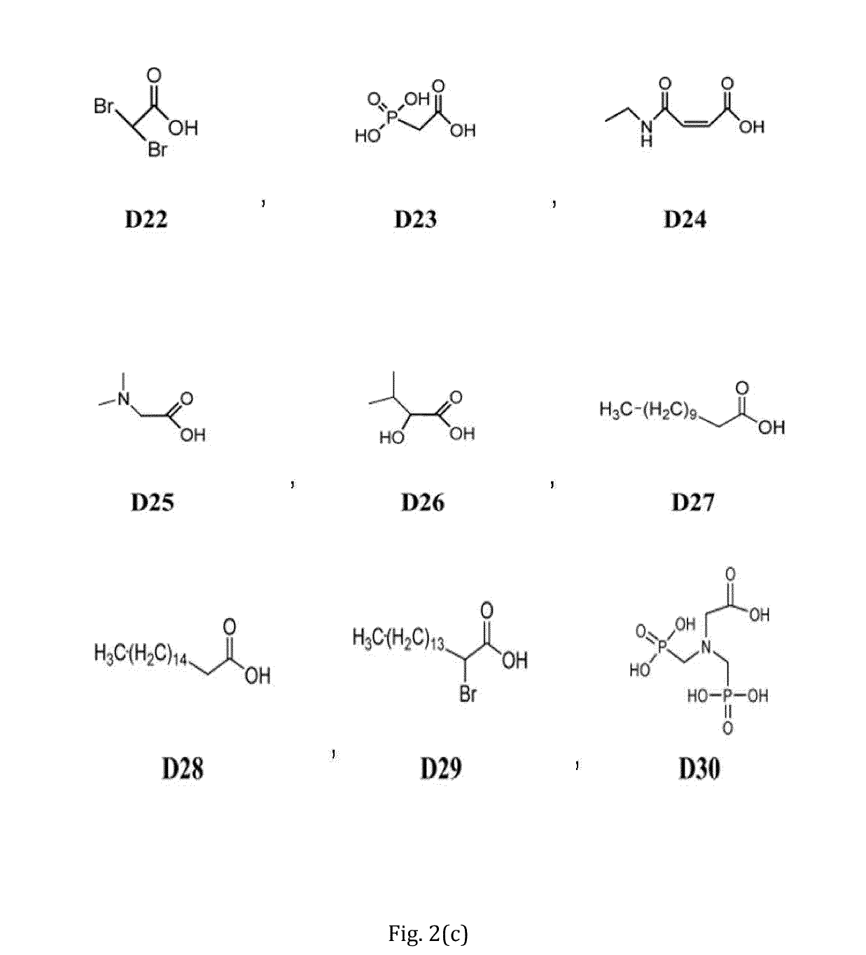

As used herein, the term “Ui” encompasses any member of the library that undergoes amide bond formation to couple a core amino compound with a carboxylic acid, wherein the letter code “U” represents 5′-amino-5′-deoxy uridine of the core amino compound and “i” is any integer from 1 to 30 according to D1-D30 of carboxylic acid described as FIG. 2, for example, U27 is the coupling product of 5′-amino-5′-deoxy uridine and D27 of carboxylic acid.

As used herein, the term “Aj” encompasses any member of the library that undergoes amide bond formation to couple a core amino compound with a carboxylic acid, wherein the letter code “A” represents 5′-amino-2′,5′-di-deoxy arabinosyl uridine and “j” is any integer from 1 to 30 according to D1-D30 carboxylic acid described above.

As used herein, the term “Cn” encompasses any member of the library that undergoes amide bond formation to couple a core amino compound with a carboxylic acid, wherein the letter code “C” represents butan-1-amine and “n” is any integer from 1 to 28 according to D1-D28 carboxylic acid described above.

As used herein, the term “Sph-1” and “Sph-2” refer to respectively sphingosine analogs which share structural similarities to U27.

The term “2-(1H-benzotriazol-1-yl)-1,1,3,3-tetramethyluronium hexafluoro-phosphate (HBTU)” is a coupling reagent used in amide bond formation.

The term “diisopropyl ethyl amine (DIEA)” is an another coupling reagent used in amide bond formation.

The“3-(4,5-dimethylthiazol-2-yl)-2,5-diphenyl tetrazolium bromide (MTT) reagent” is the reagent of MTT test which has been used to test cell viability.

The “Dimethyl sulfoxide (DMSO)” is the organosulfur compound with the formula (CH₃)₂SO and is miscible in a wide range of organic solvents as well as water.

In accordance with some embodiments, an amide-based library is performed in the solution phase and comprises a plurality of amides prepared by coupling an amine with a carboxylic acid, wherein pKa of said amine is greater than pKa of said amide,

Preferably, the difference in pKa between said amine and said amide is at least 3.

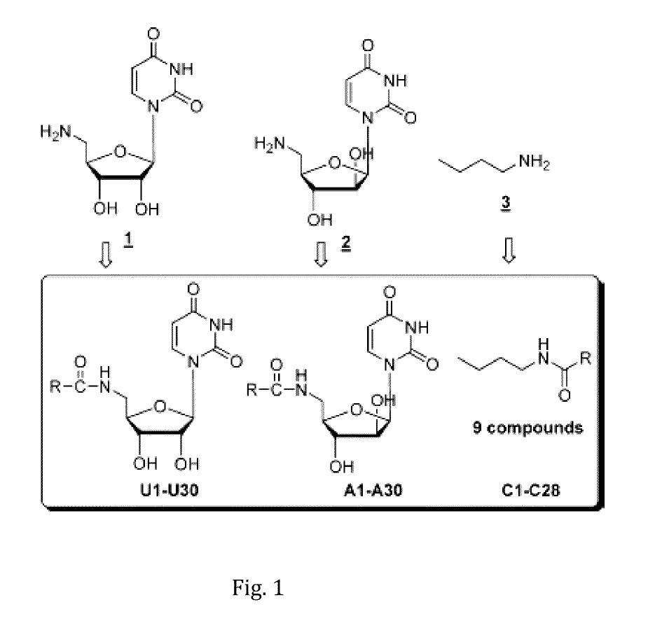

In some embodiments, as FIG. 1, said amine selected from 5′-amino-5′-deoxy uridine (U), 5′-amino-2′,5′-di-deoxy arabinosyl uridine (A), or butan-1-amine (C).

In other embodiments, said carboxylic acid selected from mono-aromatic rings, di-aromatic rings, fused rings, or aliphatic groups containing a heteroatom.

In another embodiment, the heteroatom is the phosphor or the aza acid.

More particularly, in some embodiments said carboxylic acid is selected from any one of D1-D30 as FIG. 2.

In certain embodiments, the library disclosed herein further contains analogs of U27, with the proviso when said amine is 5′-amino-5′-deoxy uridine and said carboxylic acid is dodecanoic acid. More particularly, the analogs are sphingosine analogs.

In accordance with some embodiments, a method for constructing the library is provided coupling an amine with a carboxylic acid via amide bond formation comprising following steps:

preparing said amine and said carboxylic acid respectively as a stock solution 1 and a stock solution 2;

mixing stock solution 1 with HBTU as a mixture 1;

mixing stock solution 2 with DIEA as a mixture 2; and

adding the mixture 2 into the mixture 1 to form the member of library.

In a specific embodiment, the stock solution is the stock solution of DMSO.

In some embodiments, a method for screening a drug candidate is provided which comprises:

providing an amide-based library described above;

diluting said amide-based library in water-phase;

incubating each amide in the library with a cell line; and

treating the amide of the library and the cell line with a bioassay reagent and recording the absorbance.

In some embodiments, the cell line is A549 or MCF7 cell line. In some exemplary embodiments, the bioassay reagent is 3-(4,5-Dimethyl-2-thiazolyl)-2,5-diphenyl-2H-tetrazolium bromide (MTT) reagent. Furthermore, in some embodiments, method for screening a drug candidate further comprising a molecular docking step for verifying bioactivity of each amide.

Accordingly, the present invention has the advantages as follows:

(1) A simple method is provided in the invention for screening an in vitro solution-derived library using the bioassay at the cellular level.

(2) The invention is helpful in the quest of novel hit compounds, and it also shows enough sensitivity to detect bioactive compounds.

(3) In the invention, the hit compound may be further modified as a potential hit compound through a series of high throughput screening (HTS).

(4) The invention can be used in investigation of the mechanism which is responsible for the inhibition proliferation of cancer cells.

(5) In the invention, nucleoside analogs are provided to be used as prodrugs to target herpes simplex virus thymidine kinase gene.

(6) In the invention, diluting said library proceeds in the water-phase which differs from diluting in the buffer known in the art. Thus, a simulated condition which is closer to in vivo biological conditions is provided.

(7) Because of diluting in water-phase, filtering the water to remove impurities of said amide-based library is more convenient without any organic solvent. Furthermore, more suitable non-cytotoxic drug candidates are quickly assayed by this method.

### Example 1

### General Procedure for Coupling of the Amino Compounds with Carboxylic Acids in Solution Phase

In the example 1, the development of nucleoside analogs was focused to be used as prodrugs to target herpes simplex virus thymidine kinase gene. Thus, 5′-amino-5′-deoxy analogues of pyrimidine nucleosides set as a core compound. A library was constructed using a solution-phase synthesis through coupling of three core amino compounds with 30 carboxylic acids via amide bond formation. (see FIG. 1 and FIG. 2). The simplified structural core compound butan-1-amine was selectively coupled with 9 carboxylic acids as control. The reagents used in the amide bond formation was core amine (1 mg, 4 μmol), carboxylic acid (1 eq), diisopropyl ethyl amine (DIEA) (1.2 eq) and 2-(1H-benzotriazol-1-yl)-1,1,3,3-tetramethyluronium hexafluorophosphate (HBTU) (1.1 eq). Both the starting core amine and the carboxylic acids were prepared as a stock solution of DMSO at a concentration of 0.1 mmol/200 μL and 5 umol/10 μL, respectively. HBTU and DIEA were dissolved in DMSO as a concentration of 5 umol/10 μL, respectively. Each of the acid portion was firstly mixed with HBTU in a plastic tube for 30 s, followed by the addition of a mixture of core amine (10 μL) and DIEA (10 μL) in a total volume of 40 μL. All vials were shaked for 1 min. A portion of the mixture (10 μL) was transferred to a novel tube followed by addition of 990 μL of water as a coupling product solution.

### Example 2

### Cytotoxicity Studies by MTT Assay

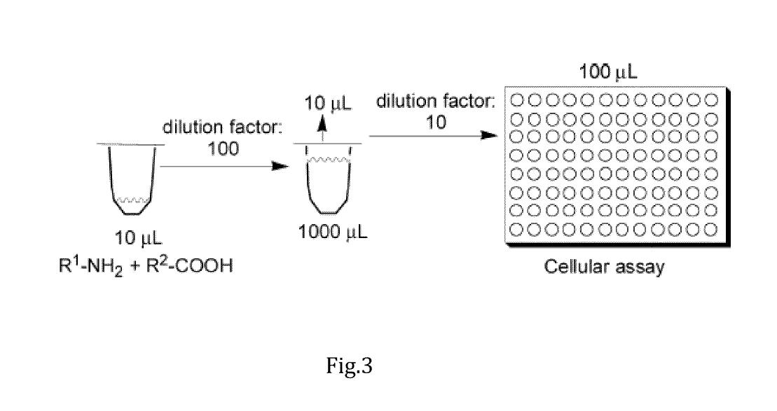

The cell lines were used in the present invention, including A549 (Human type II epithelial cell line, from American Type Culture Collection, Manassas, Va.) and MCF7 (solid human estrogen receptor positive breast carcinoma). A 10 μl coupling product solution was added into the well of microtiterplate planted with 100 μl of above mentioned cell lines in a concentration of 30000 cells/mL. Furthermore, the coupling product in each well was diluted before transferring to the plate. Thus the appropriate working concentration could be determined since the cellular survival ratio of most compounds acting as negative control is greater than 80%. The method was illustrated in FIG. 3. After an incubation of 2 days, the supernatants were washed, followed by adding MTT reagents. After 4 hours, absorbance at 580 nm was recorded according to the usual protocol.

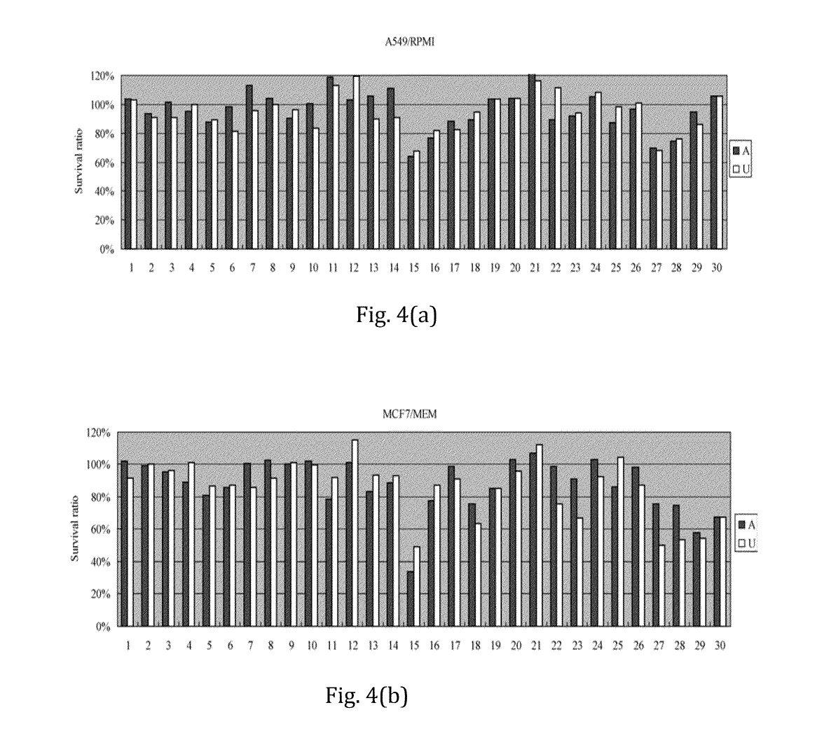

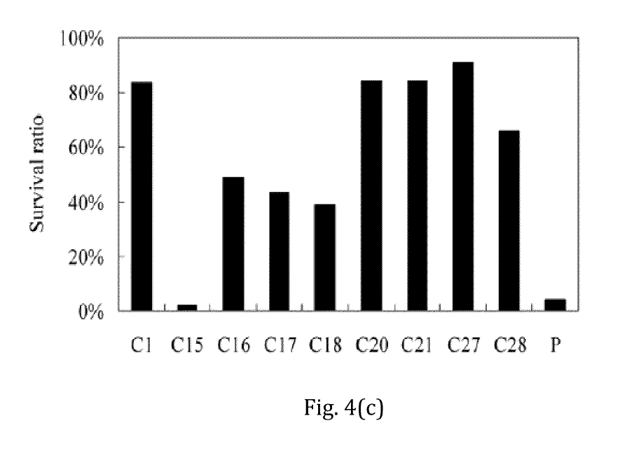

As shown by MTT assay results (FIGS. 4a-c), the cellular survival ratio for the majority of the products was over 60% suggesting the absence of cytotoxicity. On the other hand, the coupling products U27, A15, C15, and C18 exhibited biological activity. These potential compounds were further prepared and purified on flash chromatography to be submitted for a “clean” analysis. In contrast, the evaluation of U15 was disregarded due to the higher activity of its 2_-epimer A15 against both A549 and MCF7 cell lines.

Unexpectedly, a subtle cytotoxicity of U27 was evident (FIG. 4b and supporting information: S16, S17). As a control, a referential core compound: butan-1-amine was coupled with the corresponding acid moieties to provide C27 (FIG. 4b).

### Example 3

### Lipid-Containing Compounds Used in the Bioassay

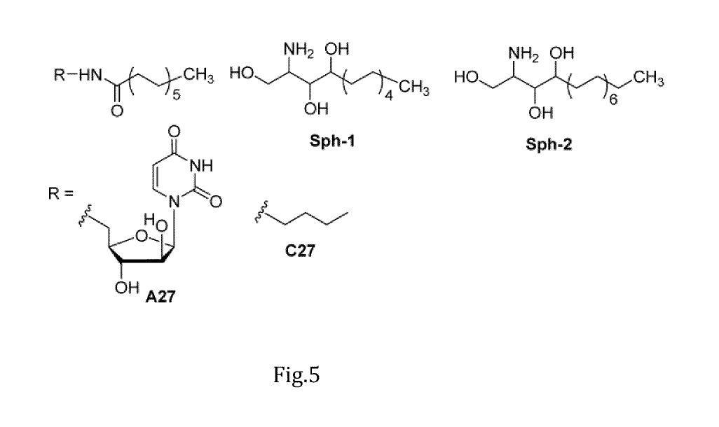

Since U27 shares structural similarities to sphingosine, the sphingosine analogs Sph-1 and Sph-2 (carbon length of 13 and 18, respectively), were prepared for comparison purposes (FIG. 5). While the bioactivity was mainly due to both the lipid part and the hydrophilic head, the hydrophilic moieties of sphingosine are more effective in inducing cytotoxicity. The hydrophilic moieties of sphingosine were capable to induce specific proapoptotic signals that might account for cytotoxicity.

### Example 4

### Molecular Docking Studies

In Example 4, the coupling products provided to clarify the probable binding mechanisms through molecular docking was performed. The START, known as a domain of steroidogenic acute regulatory protein-related lipid transfer (StARD10), had been reported to be overexpressed in breast cancer. In addition, the START domain of ceramide transport (CERT) protein was known for its transferring ability of natural Derythro ceramides, mainly used for transporting from ER to Golgi apparatus. The two START domains had similar characteristics and consist of 210 and 250 amino acids, respectively. The cavity of CERT START domain comprised a line of hydrophobic and polar charged heads.

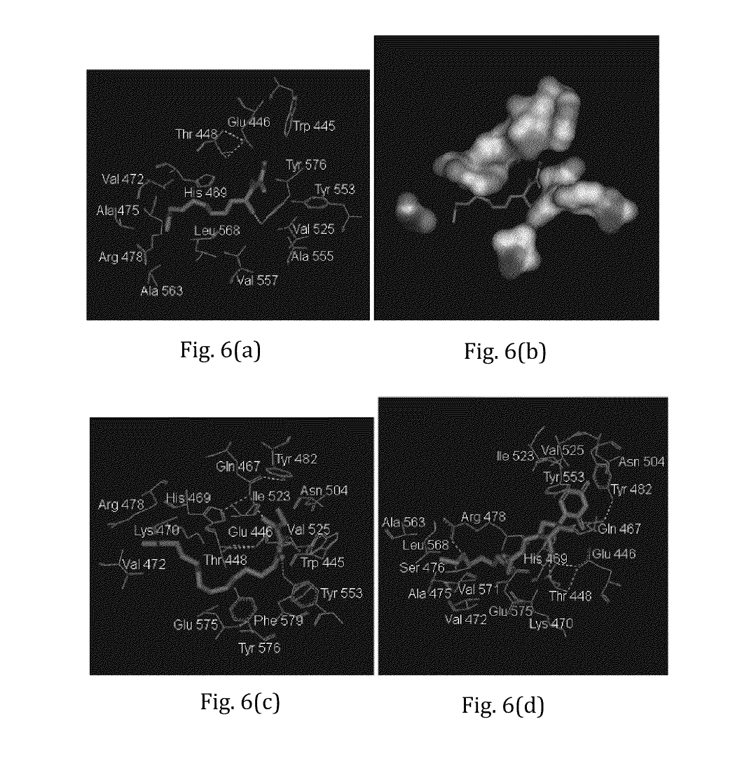

According to the crystal structure of the complex formed by CERT domain of 2e3n with ceramides having acyl groups of various lengths, the hydrogen bond formed by the hydrophilic head of the substrate within the deep active site played a critical role for the biological activity. Notably, the OH group at C1 forming a hydrogen bond with the guanidine group of arginine-442 was crucial. In Example 4, the docking results (FIGS. 6a-c) suggested a similar interaction formed among numerous amino acid residues including hydrophilic and hydrophobic contacts.

Interestingly, the 4-OH group formed a hydrogen bond to OH of tyrosine-576 closing to the tyrosine-553, which was responsible for the hydrogen bond to the amide group of natural ceramide. Impressively, in the case of Sph-2, the 2-NH2 and 4-OH groups formed hydrogen bonds to glutamine-467 and tyrosine-553, respectively (FIG. 6c). Similarly, although the 3-OH group of U27 formed a hydrogen bond to the OH of threonine-448, the cavity was still able to accommodate the pyrimidine base ring (FIG. 6d). The results suggested that the START domain was the site potentially responsible for mediating apoptosis through these lipid analogs. During the crude assay of C-series compounds, an unexpected bioactivity of C18 against both A549 and MCF7 was evident (See Table 2).

TABLE 2
IC 50 of the Compounds Purified from Independent Synthesis

| Samples | | C18 | U18 | D18 | C15 | A15 | D15 | U27 | Sph-1 |
|---|---|---|---|---|---|---|---|---|---|
| Cell | A549 | 100 | >100 | >100 | 18 | >100 | 84 ± 16 | >100 | 50 |
| lines | MCF7 | 87 | >100 | >100 | 8 ± 5 | >100 | 26 ± 2 | ca. 100 | 40 |
| (μM) | | | | | | | | | |

| Samples | | Sph-2 | A16 | C16 | X16 | D16 | U1 | Cisplatin |
|---|---|---|---|---|---|---|---|---|
| Cell | A549 | 38 | >100 | >100 | >100 | >100 | >100 | 8 ± 3 |
| lines | MCF7 | 20 | >100 | >100 | >100 | >100 | >100 | 25 ± 6 |
| (μM) | | | | | | | | |

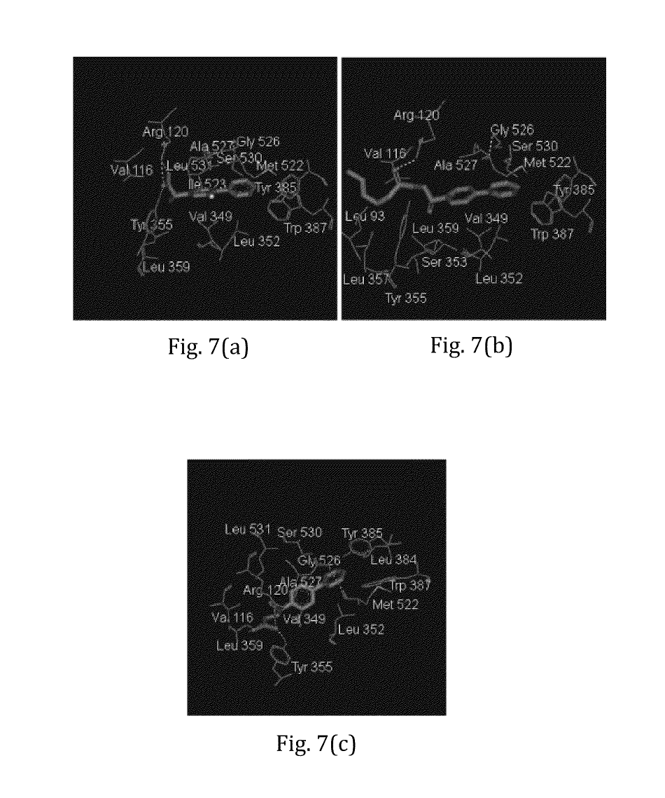

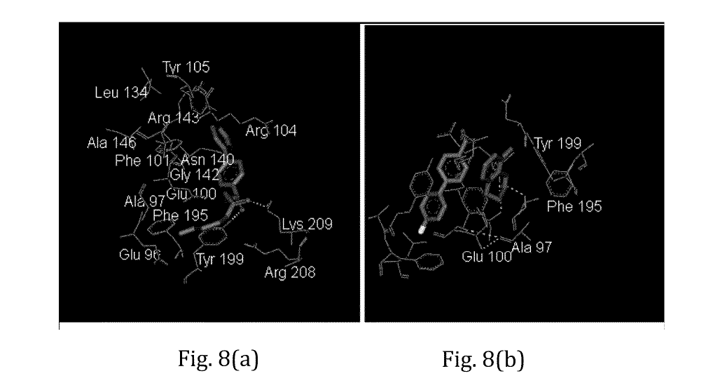

Acid moieties D18, 4-([1,1′-biphenyl]-4-yl)-4-oxobutanoic acid, also known as fenbufen is a member of the non-steroid anti-inflammatory drugs (NSAIDs). As an inhibitor targeting cyclooxygenase, fenbufen is effective in rheumatoid arthritis and osteoarthritis. Although NSAIDs such as diclofenac might inhibit tumor growth in vitro (IC50: 360 mμM) and in vivo, there was no significant improvement in cytotoxicity through modification of other NSAIDs, for instance fenoprofen. Therefore, fenbufen (D18) was an interesting probe for studying the relationship between these two diseases through structural modification. Furthermore, C18 was a potential hit and might act as a starter for further screening of a new hit compound or even a lead compound. The potential enzyme targeted by C18 has been suggested to be cyclooxygenase (COX). COX-2 is an inducible cyclooxygenase isoform that plays a major role in inflammation and has been found to be hyperexpressed in several human tumors. COX-2 overexpression is involved in cancer growth and invasion. Various NSAIDS have been studied as anticancer drugs. Since the bioactive flurbiprofen mimics our butylfenbufen, the 3-D crystal structure of the complex formed by prostaglandin H2 synthase-1 from goat with flurbiprofen was chosen as model (FIG. 7a). When examining the inner structure formed by flurbiprofen within the active site, butyl fenbufen-rather than fenbufen-shared a similar environment (FIGS. 7b, c). This was likely to be ascribed to the hydrogen bond formed between the oxo group and the terminal amino group of arginine-120 and the van der Waals contact formed between butyl group and Val 116 as well as Leu93. Instead of a hydrogen bond formed between the oxo group and arginine-120 as for butyl fenbufen, fenbufen formed a hydrogen bond between the oxo group and tyrosine-355. The slightly incline-to-the-left structure weakened the nonpolar contact of the biphenyl ring with the deep pocket of active site, thereby diminishing its activity. Nevertheless, in spite of the success in the elucidation of the structure-activity relationship through molecular-docking, the apoptotic mechanism in terms of the block of COX-2 might not fully account for the subtle cytotoxicity of butylfenbufen. Accordingly, targeting cyclooxygenase might be not the sole antiproliferative mechanism of NSAIDs. Therefore, the protein data bank (PDB) was examined to find the related report regarding the probable human-derived enzyme responsible for the proapoptotic activity. The screening results obtained by confining to the substructure of diphenyl rings indicated that proteins of the Bcl-x or Bcl-2 families overexpressed in many cancers fit these criteria. However, a contradictory docking result for butylfenbufen was obtained (FIG. 8a). In contrast to the report of the extension of the biphenyl ring of 4-fluoro-1,1-biphenyl-4-carboxylic acid (4-FC) into the deep pocket of the active site (FIG. 8b), an inverted binding of the butylfenbufen was evident. Furthermore, most of the binding energy of this model was resulting from the coverage of the biphenyl group on the protein surface, a result that was not consistent with 4-FC's. The proapoptotic activity of butylfenbufen is thus unlikely to occur via inhibition of Bclx proteins. Acid moieties D15, known as ethacrynic acid, were classified as a group of diuretics that can block Na⁺—K⁺-2Cl⁻ symporter in the thick ascending limb of the loop of Henle.

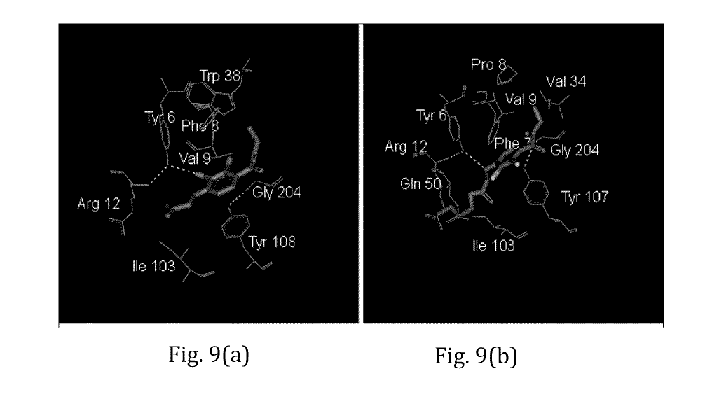

They were generally used in patients with acute pulmonary edema. Furthermore, D15 is an inhibitor of betaglutathiontransferase (BGTT) whose upregulation has been associated with drug resistance during chemotherapy of various cancers. Further analysis of the binding pattern between C15 and BGTT was performed by using the DS program according to 3D-data of 2gss from the PDB bank (FIG. 9a).

Compared to ethacrynic acid, the extra butyl group extended into the deep pocket, an unidentified extra site freely available for extra stabilization (FIG. 9b). Furthermore, both residues of tyrosine-107 and phenyl alanine-7 near the entrance of the pocket provided a primary stabilization for the benzene ring of C15 through a pi-pi stackering, a mimic of a sandwich complex. The terminal amido group in the glutamine-51 residue might provide indirect polar contact with the amido group of butyl ethacrynic amide. Interestingly, despite the presence of the butyl group, there was a loose space surrounded by the residues of glutamine-64, serine-65 (not specified in FIG. 9b) and the terminal butyl group of butyl ethacrynic amide. This might provide a base for future modifications of the butyl group in order to develop potential inhibitors.

Summarization above results, the invention thus provided a new avenue to explore new potential compounds based on the concept of “old drug new use.”

Furthermore, a simple method was provided for screening an in vitro solution-derived library using the MTT assay at the cellular level. The probe screening of the library was helpful in the quest of novel hit compounds such as C18. It also showed enough sensitivity to detect bioactive compounds based on a relative survival ratio of 60% for controls. The hit compound C15 might be further modified as a potential hit compound through a series of high throughput screening (HTS). Investigation of the mechanism responsible for the inhibition of proliferation of cancer cells was performed by molecular docking using the DS program. The cytotoxicity of U27, C18 and C15 discovered through the method described in the invention was likely to occur mainly via binding mediated inhibition of apoptosis-regulating enzymes.

1. An amide-based library performed in a solution phase comprising a plurality of amides prepared by coupling an amine with a carboxylic acid, wherein pKa value of said amine is greater than pKa value of said amide.

2. The library of claim 1, wherein the difference in the pKa value between said amine and said amide is at least 3.

3. The library of claim 1, wherein said amine is selected from 5′-amino-5′-deoxy uridine, 5′-amino-2′,5′-di-deoxy arabinosyl uridine, or butan-1-amine; and
D said carboxylic acid is selected from mono-aromatic rings, di-aromatic rings, fused rings, or aliphatic groups containing a heteroatom.

4. The library of claim 3, wherein said carboxylic acid is selected from benzoic acid, 4-vinylbenzoic acid, 4-butylbenzoic acid, 2-methoxybenzoic acid, 3,4,5-trimethoxybenzoic acid, 2-hydroxy-4-methylbenzoic acid, 4-(methylamino)benzoic acid, 6-methylnicotinic acid, 5-oxopyrrolidine-2-carboxylic acid, 2-hydroxy-2-phenylacetic acid, 2-(4-isobutylphenyl)propanoic acid, 5-(2,5-dimethylphenoxy)-2,2-dimethylpentanoic acid, (E)-3-(4-hydroxy-3-methoxyphenyl)acrylic acid, (E)-4-phenylbut-3-enoic acid, 2-(2,3-dichloro-4-(2-methylenebutanoyl)phenoxy)acetic acid, 3-(4-fluorobenzoyl)benzoic acid, 3′4′-difluoro-4-hydroxy-[1,1′-biphenyl]-3-carboxylic acid, 4-([1,1′-biphenyl]-4-yl)-4-oxobutanoic acid, 3-(1H-indol-3-yl)propanoic acid, 8-ethyl-5-oxo-2-(piperazin-1-yl)-5,8-dihydropyrido[2,3-d]pyrimidine-6-carboxylic acid, (2S,4S,5R,6R)-5-acetamido-2,4-dihydroxy-6-((1R,2R)-1,2,3-trihydroxypropyl)tetrahydro-2H-pyran-2-carboxylic acid, 2,2-dibromoacetic acid, 2-phosphonoacetic acid, (E)-4-(ethylamino)-4-oxobut-2-enoic acid, 2-(dimethylamino)acetic acid, 2-hydroxy-3-methylbutanoic acid, dodecanoic acid, heptadecanoic acid, 2-bromohexadecanoic acid, and 2-(bis(phosphonomethyl)amino)acetic acid.

5. The library of claim 3, wherein the library further contains analogs, with the proviso when said amine is 5′-amino-5′-deoxy uridine and said carboxylic acid is dodecanoic acid.

6. A method for screening a drug candidate comprising:
providing an amide-based library of claim 1;
diluting said amide-based library in a water-phase;
incubating each amide in the library with a cell line; and
treating the amide of the library and the cell line with a bioassay reagent and recording the absorbance.

7. The method of claim 6, wherein the cell line is A549 or MCF7 cell line.

8. The method of claim 6, wherein the bioassay reagent is 3-(4,5-Dimethyl-2-thiazolyl)-2,5-diphenyl-2H-tetrazolium bromide (MTT) reagent.

9. The method of claim 6, which further comprises a molecular docking step for verifying bioactivity of each amide.
